(19) United States
(12) Patent Application Publication
(10) Pub. No.: US 2008/0222964 A1
(43) Pub. Date: Sep. 18, 2008

(54) Door actuation method

(76) Inventors: Pierre Claude Longuemare, Paris (FR); Oliver Benthaus, Wuppertal (DE); Werner Amshoff, Wuppertal (DE)

Correspondence Address: DELPHI TECHNOLOGIES, INC., M/C 480-410-202, PO BOX 5052, TROY, MI, 48007, US

(21) Appl. No.: 12/075,300

(22) Filed: Mar. 10, 2008

(30) Foreign Application Priority Data
Mar. 12, 2007 (EP) 07005070.3

(51) Int. Cl. E06B 3/32; B60J 5/06

(52) U.S. Cl. 49/506; 296/146.4

(57) ABSTRACT

The invention relates to a method of actuating a door, in particular of a motor vehicle, wherein an electric drive motor coupled to the door is controlled by a motor control on a manual actuation of the door such that the drive motor exerts a force onto the door by which a system-inherent force countering the manual actuation is at least partly compensated. The invention also relates to an apparatus for the carrying out of a method of this type.

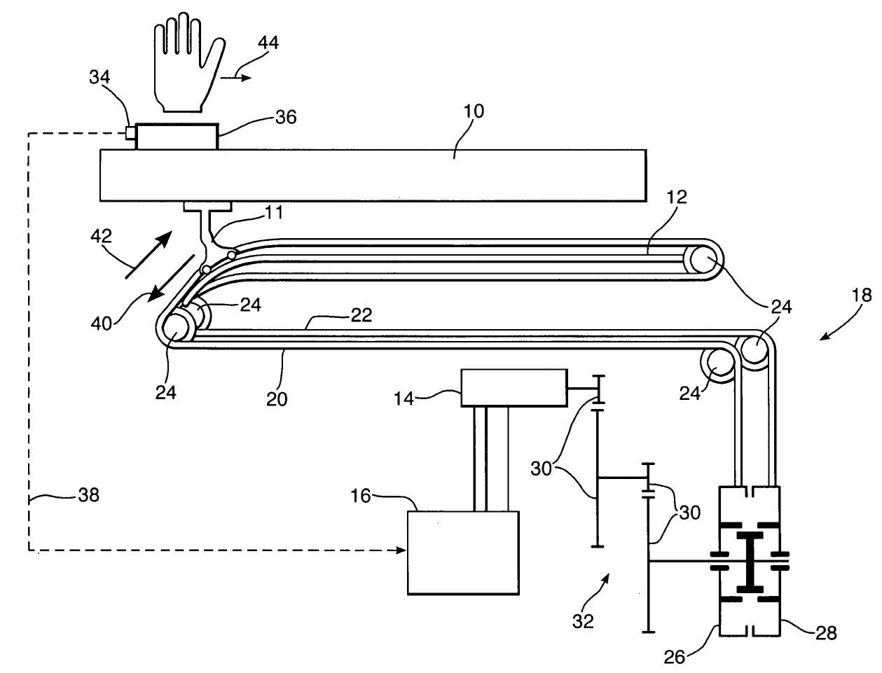

### TECHNICAL FIELD

The present invention relates to a method of actuating a door, in particular of a vehicle, coupled with an electric drive motor.

### BACKGROUND OF THE INVENTION

In a known method of the initially named kind, the door, e.g. a sliding door of a motor vehicle, is opened or closed automatically in the case of activation by a remote control, for example by a transponder key. The problem exists in this connection that the time period of a complete opening or closing process is typically in the range of some seconds, which can be felt to be long by a person actuating the door under certain circumstances, e.g. in adverse weather conditions or in case of panic. The automatic closing process cannot be accelerated in such situations since the drive motor moving the door is usually feedback-controlled to a substantially constant opening or closing speed.

Some conventional door actuation apparatus additionally provide the possibility of a manual actuation of the door in addition to an automatic movement of the door. In this connection, for the manual actuation of the door, either a frictional force inherent in the total door drive mechanism, including an internal resistance of the drive motor, has to be overcome so that an increased force effort is required for the manual actuation of the door. Or the drive mechanism can be uncoupled from the door by means of a coupling mechanism by which the manufacturing costs of the door drive apparatus are substantially increased.

### SUMMARY OF THE INVENTION

It is the underlying object of the invention to provide a door actuation method which permits a manual actuation of an automatically actuable door with a minimum force effort.

A method having the features of claim 1 is provided to satisfy the object.

In accordance with the invention, an electric drive motor coupled with a door, for example of a vehicle, and in particular of a motor vehicle, is controlled by a motor control on a manual actuation of the door such that the drive motor exerts a force on the door by which a system-inherent force acting against the manual actuation is at least partly compensated.

In this context, all those forces are combined under the term “system-inherent” which acts against a manual actuation due to the construction of the coupling mechanism between the drive motor and the door, the suspension of the door as well as the mass of the door and thus have to be overcome for the manual movement of the door. They can, for example, be friction forces of cable controls or of other force transmission means of the drive mechanism.

The invention is based on the general idea of supporting the manual actuation of a door by an electric drive motor coupled with the door such that a person actuating the door can move the door with a minimum expenditure of force. The force exerted onto the door by the drive motor can be selected to be so large that the system-inherent force acting against the manual actuation is largely neutralized by the drive motor.

It can alternatively be possible that the degree to which the system-inherent force acting against the manual actuation is compensated is set by a person primarily actuating the door actuation apparatus. The setting of the degree of compensation can take place continuously or in steps. In this manner, a vehicle owner or user can e.g. adapt the door actuation apparatus to his needs.

Since the drive motor is used for the support of the manual actuation of the door, no complex and expensive coupling has to be provided to separate the drive motor from it on a manual actuation of the door. Instead, a particularly easily moving manual door actuation is achieved in accordance with the invention only by those components which anyway have to be present in an automatic door actuation device, namely the drive motor and the drive mechanism by which the drive motor is coupled with the door.

Furthermore, the method in accordance with the invention can also be implemented in already existing door actuation apparatus since, for this purpose, only the motor control has to be adapted such that it can control the drive motor in the manner in accordance with the invention.

It is pointed out that a “door” in the sense of the invention cannot only be a sliding door, a pivoting sliding door, a pivoting door or a wing door, but can also be an engine hood, a tailgate, a trunk lid or the like.

Advantageous embodiments of the invention can be seen from the dependent claims, from the description and from the drawing.

In accordance with an embodiment of the method in accordance with the invention, the drive motor is controlled such that the strength of the force exerted onto the door by the drive motor is substantially independent of the speed at which the door is manually actuated. It is ensured in this manner that a person has to apply a reduced force expenditure which always remains constant for the closing or opening of the door independently of whether said person opens the door fast or slowly.

In accordance with a further embodiment, the drive motor is acted on by a current of a predetermined magnitude and the voltage applied to the drive motor is left open, i.e. no fixed voltage value is predetermined. The force exerted onto the door by the drive motor can be set by the predetermination of the magnitude of the current supplied to the drive motor, whereas the left-open voltage at the drive motor is adopted automatically in dependence on the speed of the drive motor and thus ultimately on the door actuation speed. The voltage at the drive motor thus increases as the door actuation speed or the speed of the drive motor increases. This has the result that the drive motor admittedly delivers different powers at different door actuation speeds, but always applies a predetermined force onto the drive mechanism, and thus ultimately onto the door, due to the predetermined current in order to allow the manual actuation of the door to appear as a defined easy motion for the person actuating the door.

In accordance with a variant, the predetermined current can be preset to a fixed value. This fixed value can, for example, be selected such that the resulting force which is exerted onto the door by the drive motor neutralizes the system-inherent force which has to be overcome on a manual actuation of the door of a vehicle parked on a horizontal base.

It is alternatively possible to set the predetermined current in dependence on external influences such as the inclination of the vehicle or the ambient climate. The fact can e.g. be taken into account in this manner that e.g. particularly low external temperatures may make increased forces necessary for the actuation of the door or that the door of a vehicle parked on a slope may be more difficult to move under certain circumstances due to the mass of the door. The force exerted onto the door by the drive motor can thus be increased by an increase in the current, for example, to compensate the mass of a door to be pushed uphill which plays a larger role. The inclination of the vehicle can be determined in a manner known per se e.g. by a tilt sensor.

By an adaptation of the magnitude of the current supplied to the drive motor to the respective external circumstances, an easy manual actuation of the door can be ensured in practically all situations occurring in the use of the vehicle for its intended purpose.

Alternatively or additionally, the predetermined current to be set can be determined with reference to the deflection of a door handle of a door at which the door is manually actuated.

In accordance with a further embodiment, the door is substantially only actuated by the drive motor on an actuation by means of a remote control. This is therefore an automatic operation of the door actuation device.

The drive motor used in automatic operation for the actuation of the door is preferably the same drive motor which is also used for the support in accordance with the invention of a manual actuation of the door. It is, however, generally also possible to use two different drive motors for the manual actuation and for the automatic actuation of the door.

In automatic operation of the door actuation apparatus, the motor control can be in an automatic mode known per se so that the door moves at a predetermined, substantially constant speed. The automatic operation is thus different to the manual operation in which the motor control is in a manual mode and the magnitude of the current supplied to the drive motor—and not the speed of the drive motor—is predetermined.

In accordance with a further embodiment, the motor control changes from the automatic mode into the manual mode when a manual intervention into an automatic actuation process of the door is detected. In other words, the door actuation apparatus switches from automatic operation in which the drive motor is operated at a predetermined speed into the manual operation in which the drive motor is operated with a predetermined current as soon as a person manually accelerates or slows down an opening or closing process taking place.

The manual intervention can e.g. be detected by an actuation of a door handle of the door, for example by means of a suitable contact sensor.

Alternatively or additionally, the door can form part of an electromagnetic resonant circuit and the manual engagement can be detected by a change in the impedance of the resonant circuit. This permits the detection of a manual intervention even when a person actuating the door does not touch the door handle, but acts on the door at a different position thereon, e.g. slides or pushes the door open or closed using his foot.

A further subject of the invention is moreover a door actuation apparatus having the features of claim 12, by which the advantages named above can be achieved correspondingly. In accordance with advantageous embodiments, the apparatus is made such that the previously explained embodiments of the method in accordance with the invention can be carried out accordingly.

### BRIEF DESCRIPTION OF THE DRAWING

The invention will be described in the following purely by way of example with reference to an advantageous embodiment and to the enclosed drawing.

### DESCRIPTION OF THE PREFERRED EMBODIMENT

The only FIGURE shows a schematic representation of an apparatus in accordance with the invention for the actuation of a door, in the present embodiment a sliding door 10 of a motor vehicle which is supported at a guide rail 12 by means of a carriage 11 and which is movable along the guide rail 12 relative to a chassis of the vehicle for the opening and closing of the door.

The door actuation apparatus includes an electric drive motor 14 which is controlled by a motor control 16 and is coupled to the sliding door 10 via a drive mechanism 18.

The drive mechanism 18 includes a first cable control 20 and a second cable control 22 which are guided by a plurality of guide rollers 24. Each cable control 20, 22 has an end at the door side which is connected to the carriage 11. An end section of the first cable control 20 at the motor side can be wound onto a first drum 26 and an end section of the second cable control 22 at the motor side can be wound onto a second drum 28. The drums 26, 28 are connected to the drive motor 14 by a transmission 32 comprising a plurality of mutually engaging toothed wheels 30

If the motor control 16 receives an activation signal from a remote control such as a transponder key, said activation signal indicating that an opening or closing process of the sliding door 10 is desired, the motor control 16 controls the drive motor 14 such that it moves the sliding door 10 in the desired direction via the drive mechanism 18. The activation of the motor control 16 by the remote control has the effect that the motor control 16 works in an automatic mode in which the drive motor 14 is controlled such that the sliding door 10 moves along the guide rail 12 at a substantially constant speed. For this purpose, the motor control 16 controls the speed of the drive motor 14 during the opening or closing procedure.

If the motor control 16 determines that a person is intervening in the automatic opening or closing procedure, for example to slow down a closing process or to accelerate an opening process due to panic or to adverse weather, the motor control 16 changes from the automatic mode into a manual mode.

A contact sensor 34 can, for example, be provided for the detection of the intervention of a person in an automatic opening or closing process, said contact sensor being arranged in the region of a door handle 36 of the sliding door 10 and being connected to the motor control 16, as is indicated by the arrow 38. Alternatively or additionally, the sliding door 10 can form a part of a electromagnetic resonant circuit and an intervention of a person in an automatic opening or closing process can be detected by a change in the impedance of the resonant circuit.

In the manual mode of the motor control 16, no speed control of the drive motor 14 takes place, but current is rather supplied to the drive motor 14 at a predetermined magnitude and polarity so that the drive motor 14 introduces a predetermined force into the system. At the same time, the voltage applied to the drive motor 14 is left open so that it can be adopted automatically in dependence on the speed at which the sliding door 10 is moved manually. The voltage automatically adopted in accordance with the speed of the dive motor 14 is the higher, the faster the sliding door 10 is moved manually.

The magnitude of the predetermined drive current is selected such that a system-inherent force 40 acting against the manual actuation of the sliding door 10 is at least partly compensated. The system-inherent force 40 is the sum of all the forces which are caused by the door actuation apparatus and which a person has to overcome to move the sliding door 10 manually. The system-inherent force 40 is therefore composed inter alia of frictions forces occurring in the drive mechanism 18, of forces caused by the support of the sliding door 10 and of forces resulting from the inertia of the sliding door 10.

The magnitude of the current supplied to the drive motor 14 in the manual mode of the motor control 16 can thus be preset to a fixed value so that the drive motor 14 exerts a force 42 onto the sliding door 10 via the drive mechanism 18 on a manual activation of the sliding door 10 which is approximately as large as the system-inherent force 40 which acts against the manual actuation when the vehicle is on a horizontal base. With a vehicle parked on a horizontal base, the system-inherent force 40 is therefore largely compensated by the force 42 introduced into the system by the drive motor 14 so that a person actuating the sliding door 10 in this case at most has to apply a minimal force 44 to move the sliding door 10.

Alternatively, a feedback control of the current supplied to the drive motor 14 can be provided by the motor control 16 such that the magnitude of the current supplied to the drive motor 14 is adapted to the respectively present system-inherent force 40. This makes it possible to take account of external circumstances in the setting of the magnitude of the current supplied to the drive motor 14 such that, on a manual actuation of the sliding door 10, a constant minimal force 44 substantially independent of external conditions has to be applied for the movement of the door.

If, for example, the vehicle is parked on a slope such that the sliding door 10 has to be pushed in a so-to-say uphill direction, the motor control 10 can provide that a correspondingly higher current is supplied to the drive motor 14 so that a person manually actuating the sliding door 10 has to apply substantially the same force for the movement of the door which would be necessary to manually actuate the sliding door 10 with a vehicle parked on the horizontal.

Suitable detection devices such as force sensors, torque sensors, current sensors and path sensors can be provided in the motor control 16, in the drive motor 14, in the drive mechanism 18 and/or at the door handle 36 for the determination of the respective current to be set. Alternatively or additionally, the motor control 16 can be connected to a tilt sensor which determines the respective tilt of the vehicle.

It is pointed out that in this manual motor control model with variable current, the magnitude of the current supplied to the drive motor 14 cannot only be set in dependence on external circumstances from actuation process to actuation process, but can also be feedback controlled during an opening or closing process for the adaptation to changing external circumstances.

It had previously been assumed that the current fixedly predetermined in the manual motor control mode or set in dependence on external circumstances is selected such that the system-inherent force 40 acting against the manual actuation is substantially completely compensated or neutralized so that the sliding door 10 can be moved with a minimal manual force 44 of almost zero.

It is, however, alternatively also possible to set the magnitude of the current supplied to the drive motor 14 such that a force 44 which is larger than zero by a defined magnitude has to be applied by a person moving the sliding door 10 for the manual movement of the sliding door 10.

The possibility can be given in this connection that the magnitude of the force 44 to be applied for a manual actuation of the sliding door 10 or the extent of the support of a manual door activation by the drive motor 14 can be preset by a user or owner of the vehicle in accordance with personal needs, for example to any desired values or in the form of fixedly predetermined steps.

If a person manually actuating the door 10 interrupts an opening or closing process, the current supply to the drive motor 14 is stopped by the motor control 16 so that said drive motor can no longer exert any force onto the door 10. Such an interruption of an opening or closing process can e.g. be detected with the help of the contact sensor 34 in that the person lets go of the door handle 36 of the door 10 and/or in that the person does not actively move the door 10 or hold it tight.

After an interruption of a manual opening or closing process, the door actuation can be continued either manually or by a corresponding actuation of the remote control in automatic operation.

Having thus described the invention, it is claimed:

1. A method of actuating a door, in particular of a motor vehicle, wherein an electric drive motor coupled to the door is controlled by a motor control on a manual actuation of the door such that the drive motor exerts a force onto the door by which a system-inherent force acting against the manual actuation is at least partly compensated.

2. A method in accordance with claim 1, wherein the drive motor is controlled such that the magnitude of the force exerted onto the door by the drive motor is substantially independent of the speed at which the door is manually actuated.

3. A method in accordance with claim 1, wherein the drive motor is charged with a current of a predetermined magnitude and the voltage applied to the drive motor is left open.

4. A method in accordance with claim 3, wherein the predetermined current is preset to a fixed value.

5. A method in accordance with claim 3, wherein the predetermined current is set in dependence on external influences such as the vehicle inclination.

6. A method in accordance with claim 1, wherein the degree to which the system-inherent force acting against the manual actuation is compensated is preset by a user.

7. A method in accordance with claim 1, wherein the door is actuated substantially only by the drive motor on an actuation by means of the remote control.

8. A method in accordance with claim 7, wherein the drive motor is controlled by the motor control such that the door moves at a predetermined speed.

9. A method in accordance with claim 1, wherein the motor control changes from an automatic mode into a manual mode when a manual intervention into an automatic actuation process of the door is detected.

10. A method in accordance with claim 9, wherein the manual intervention is detected by an actuation of a door handle of the door.

11. A method in accordance with claim 9, wherein the door forms a part of an electromagnetic resonant circuit and the manual intervention is detected by a change in the impedance of the resonant circuit.

12. An apparatus for the actuation of a door, comprising an electric drive motor coupled to the door and a motor control by which the drive motor is controllable on a manual actuation of the door such that the drive motor exerts a force onto the door by which a system-inherent force acting against the manual actuation is at least partly compensated.
